(19) United States
(12) Patent Application Publication
(10) Pub. No.: US 2025/0036345 A1
(43) Pub. Date: Jan. 30, 2025

(54) Display system in an aircraft cockpit and associated display method

(71) Applicant: THALES, Meudon (FR)

(72) Inventors: François LEULLIER, MERIGNAC (FR); Xavier BOURGERIE, MERIGNAC (FR); Sébastien DOTTE, MERIGNAC (FR)

(21) Appl. No.: 18/783,370

(22) Filed: Jul. 24, 2024

(30) Foreign Application Priority Data
Jul. 28, 2023 (FR) 2308187

(51) Int. Cl. G06F 3/14; B64D 43/00

(52) U.S. Cl. CPC G06F 3/1431; B64D 43/00

(57) ABSTRACT

A display system in an aircraft cockpit, including a plurality of display surfaces, a processing module configured to host applications capable of generating images to be displayed on one or more display surfaces, a graphic generation module configured to generate a composite graphic flow including images from one or more applications and intended to be displayed on different display surfaces, wherein each display surface is configured to receive the composite graphic flow and to extract images for display on that display surface.

### CROSS-REFERENCE TO RELATED APPLICATION

This application is a U.S. non-provisional application claiming the benefit of French Application No. 23 08187, filed on Jul. 28, 2023, which is incorporated herein by reference in its entirety.

### TECHNICAL FIELD OF THE INVENTION

This invention concerns a display system in an aircraft cockpit.

This invention also concerns a display method associated with such a display system.

### BACKGROUND OF THE INVENTION

The state of the art includes various display architectures for aircraft cockpits.

In particular, there are familiar so-called distributed or integrated display architectures that favor the availability of the display field.

In distributed architectures, each display screen is associated with a graphic generation module, also known as a GPU (Graphics Processing Unit).

This generator is used to generate graphic flows for this screen from images supplied by a processing module, for example a CPU (Central Processing Unit) type processor.

In integrated architectures (also known as “Smart Dispatch Displays”), the GPU graphic generation module and the CPU processing module are integrated into the display.

In both cases, such a CPU processing module is able to generate the corresponding graphic flows from the images supplied by the applications hosted on this processing module.

These applications depend on the use given to the corresponding display screen and may, for example, include an altimeter, a horizon, a relief of the surface overflown, etc. This display screen can thus correspond to a Primary Flight Display (PFD).

Also known per se, the cockpit display screens are at least doubled to ensure the level of availability required by the aeronautical industry.

For example, the cockpit comprises at least two primary flight displays operated by separate graphic generation modules and processing modules.

It is easy to see that the resources required to operate these different screens in an aircraft cockpit are very substantial in terms of weight, volume and wiring. This results in high production and operating costs.

### SUMMARY OF THE INVENTION

The present invention makes it possible to remedy these disadvantages and in particular proposes a display system for an aircraft cockpit which makes it possible to reduce the weight, volume and wiring required for its installation, while ensuring the level of availability required by the aeronautical field. This reduces the production and operating costs of these different resources.

To this end, the invention is aimed at a display system in an aircraft cockpit.

The device comprises a plurality of display surfaces; a processing module configured to host applications capable of generating images for display on one or more display surfaces; a graphic generation module configured to generate a composite graphic flow comprising images from one or more applications for display on different display surfaces and wherein each display surface is configured to receive said composite graphic flow and to extract images for display on that display surface.

In other beneficial aspects of the invention, the system comprises one or more of the following features, taken in isolation or in any technically possible combination:
a splitter device configured to receive said composite graphic flow and to divide it into at least two identical graphic flows intended to be received by different display surfaces;
the splitter device is a passive device, such as an optical splitter;
the graphic generation module is configured to generate a simple graphic flow comprising images from one or more applications and intended to be displayed on a single display surface;
each display surface is configured to adapt, on reception of said composite graphic flow, the images corresponding to that display surface, using configuration parameters;
an acquisition module configured to acquire each command exerted in relation to each display surface and to transmit it to the processing module;
the processing module being configured to process each command acquired by the acquisition module, as a function of the display surface corresponding to this command;
the processing module is configured to process each command acquired by the acquisition module according to a reference frame corresponding to the display surface corresponding to this command;
a main display surface connected to said graphic generation module;
at least two additional display surfaces, advantageously connected to the graphic generation module;
the processing module is configured,
in a normal operating mode, to generate a composite flow comprising images for display only by one of the additional display surfaces;
in a degraded mode of operation, generate a composite flow comprising images for display on each of the additional display surfaces;
each additional display surface being configured to receive said composite graphic flow and to extract images for display on that display surface.

The invention is also intended to display in an aircraft cockpit, including the following steps:
generating images to be displayed on one or more display surfaces, by one or more applications;
generating a composite graphic flow comprising images from one or more applications to be displayed on different display surfaces;
receiving said graphic flow composed by each display surface;
extracting images for display on the corresponding display surface.

Another goal of the invention is a computer program with software instructions that, when executed by a computer, implement the process as defined above.

### BRIEF DESCRIPTION OF THE DRAWINGS

The invention will appear more clearly when reading the description that follows, given solely as a non-limiting example and made in reference to drawings in which:

FIG. 1 is a schematic view of a labelling system according to the invention;

FIG. 2 is a schematic view of a splitter device that is part of the display system in FIG. 1;

FIG. 3 is a schematic view of a display system according to another example of realization;

FIG. 4 is a schematic view illustrating the operation of the display system of FIG. 3 in a degraded mode of operation; and

FIG. 5 is a flow chart of a display process implemented by the display system in FIG. 1 or FIG. 3.

### DETAILED DESCRIPTION

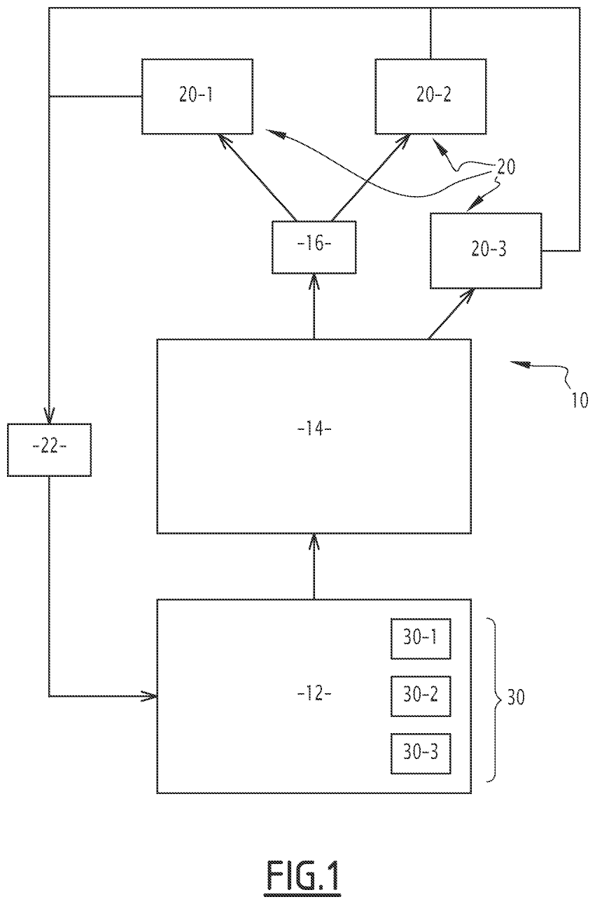

FIG. 1 illustrates a display system 10 according to the invention. This display system 10 can be used in an aircraft cockpit.

“Aircraft” means any machine that can be piloted by one or more operators from its cockpit.

The cockpit can be carried on board the aircraft, as in the case of an airplane or helicopter. Alternatively, the cockpit may be remote from the aircraft, as in the case of a drone, for example.

As illustrated in FIG. 1, the display system 10 comprises a processing module 12, a graphic generation module 14, a splitter device 16, a plurality of display surfaces 20 and an acquisition module 22. In the example shown in FIG. 1, three display surfaces 20-1 to 20-3 are shown.

The processing module 12 is, for example, a CPU-type processor configured to host applications 30, advantageously avionics applications.

FIG. 1 shows three avionics applications: 30-1, 30-2 and 30-3.

The processing module 12 may, for example, represent a CPU processor known per se, possibly associated with a random access memory and a non-volatile memory which stores the aforementioned applications 30.

In another embodiment, the processing module 12 is in any other suitable form, for example comprising a Field Programmable Gate Array (FPGA) type programmable logic circuit.

Each of the applications 30 may be used to generate images for display on at least one of the display surfaces 20.

For example, these images represent the current position of the aircraft, its horizon, its altitude, or any other data used for piloting the aircraft.

The graphic generation module 14, also known as the GPU (Graphics Processing Unit), is configured to generate graphic flows from images taken from one or more applications 30 hosted by the processing module 12.

More particularly, the generation module 14 is able to generate a simple graphic flow comprising images from one or more applications 30 intended to be displayed on a single display surface 20.

In the example shown in FIG. 1, the application 30-3 is able to generate, for example, images intended to be displayed only on the display surface 20-3. In this case, the graphic generation module 14 is used to generate a simple graphic flow from the images supplied by this application 30-3, which is then transmitted solely to the display surface 20-3.

The graphic generation module 14 can also generate a composite graphic flow comprising images from one or more applications 30 for display on different display surfaces 20.

For example, in the example shown in FIG. 1, the graphic generation module 14 is used to generate a composite graphic flow from the images supplied by applications 30-1 and 30-2. This composite graphic flow is then destined for the two display surfaces 20-1 and 20-2, as will be explained in detail later.

Each of the display surfaces 20 is designed to receive a graphic flow from the graphic generation module 14 in order to display at least some of the images contained in this flow.

In particular, in the case of a single graphic flow, the corresponding display surface 20 can be used to display all the images contained in this flow.

In the case of a composite graphic flow, the corresponding display surface 20 can be used to extract from this composite graphic flow only those images that are intended to be displayed on this display surface 20.

In particular, such a display surface 20 is configured to receive a composite graphic flow generated by the graphic generation module 14 and to extract from this flow only those images intended to be displayed by this display surface 20. To do this, the corresponding display surface 20 is configured to receive configuration parameters from the processing module 12, for example, or from the graphic generation module 14, which enables it to distinguish the images intended to be displayed on this surface from the images intended to be displayed on the other display surfaces.

To do this, each display surface 20 is adapted, for example, to apply the “cropping” type technique to extract the corresponding images.

The configuration parameters can, for example, be static, i.e., define the way in which the corresponding images are distinguished in a predetermined way, or dynamic, i.e., define the way in which the corresponding images are distinguished in a dynamic way.

These configuration parameters may, for example, be transmitted to each of the display surfaces 20 via a dedicated link or a link integrated into the graphic flow.

Advantageously, each display surface 20 is further configured to adapt the images intended to be displayed on this surface which are taken from the composite graphic flow.

For example, each display surface 20 is adapted to apply to such images a scaling operation or, according to certain examples, an operation for adapting the resolution of this image. Adaptation may, for example, take place as a function of configuration parameters transmitted by the processing module 12 or by the graphic generation module 14.

Each display surface 20 has, for example, a complete display screen or at least part of it, possibly combined with part of at least one other display screen, or at least part of a head-up display.

To supply each display surface 20 with the corresponding graphic flow, the graphic generation module 14 is connected via a suitable link. This link may, for example, be an optical link.

For display surfaces 20 designed to display only simple graphic flows, the graphic generation module 14 can be connected directly.

For the display surfaces 20 intended to receive the composite graphic flows, the graphic generation module 14 is connected via the splitter device 16.

In particular, the splitter device 16 can receive a composite graphic flow from the graphic generation module 14 and divide it into at least two identical graphic flows which are then intended to be received by different display surfaces 20.

In the example in FIG. 1, only one splitter device 16 is shown. However, it must be understood that more generally, several possible splitter devices 16 can be arranged in parallel or at least some of them sequentially to divide a single graphic flow into at least three graphic flows.

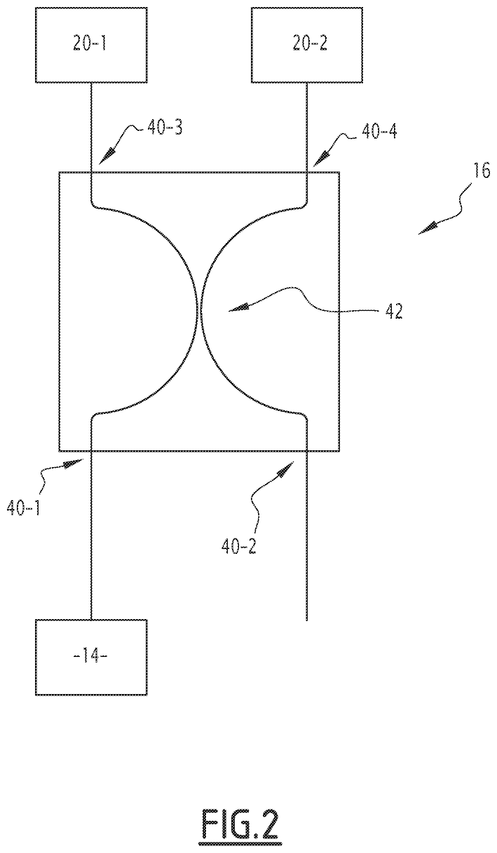

Advantageously, the splitter device 16 is a passive device. This means that this splitter device allows the corresponding flows to be separated regardless of the nature and content of the flow. Advantageously, this splitter device 16 has an optical splitter such as that shown in FIG. 2.

With reference to FIG. 2, the splitter device 16 comprises two optical input channels, i.e., channels 40-1 and 40-2, and two optical output channels, i.e., channels 40-3 and 40-4. The optical splitter device 16 also includes a mixing zone 42 for mixing the optical flows entering via the input channels 40-1 and 40-2 and then separating them into two independent optical flows which exit via the output channels 40-3 and 40-4.

In the example shown in FIG. 2, the input channel 40-1 is connected to the graphic generation module 14, while each of the output channels 40-3, 40-4 is connected to the display surface 20-1 and the display surface 20-2 respectively. In this example, input channel 40-2 is not used.

The acquisition module 22 is configured to acquire each command exerted in relation to each display surface 20 in order to transmit this command to the processing module 12.

In particular, by control exercised in relation to a display surface 20, we mean any action exercised by the operator to control or modify the display on the corresponding display surface 20.

For example, when a display surface 20 has a tactile surface, such a command describes each tactile movement exerted by the operator in relation to this display surface 20.

As an alternative or in addition, a command exercised in relation to a display surface 20, whether tactile or not, can also be input by an external input device of the CCD (Cursor Control Device) type.

The processing module 12 enables each command acquired by the acquisition module 22 to be processed as a function of the display surface 20 corresponding to this command.

In particular, the processing module 12 can process each command acquired by the acquisition module 22 according to a reference frame corresponding to the display surface 20 corresponding to this command.

In other words, the processing module 12 enables each command exercised in relation to each display surface 20 to be brought back into the source frame of reference of the images corresponding to this display surface 20.

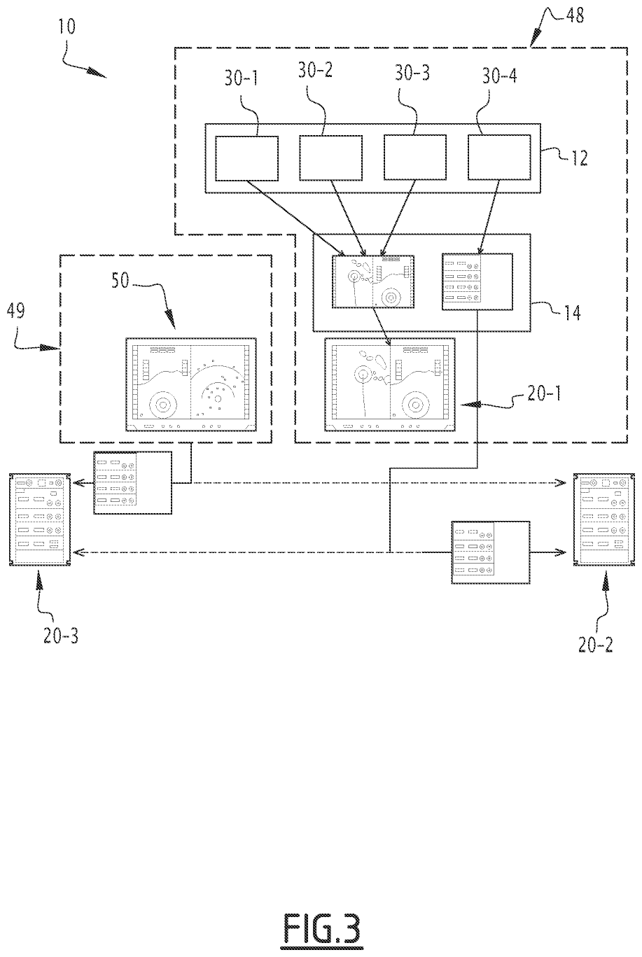

FIG. 3 illustrates another example of the display system 10.

According to this example, the display system 10 comprises a display chain 48 implemented according to an integrated or “Smart Dispatch Display” architecture.

This display chain 48 comprises a main display surface 20-1, a processing module 12 and a graphic generation module 14, as described above.

In addition, according to this example, the display chain 48 is connected to the two additional display surfaces, namely the additional display surfaces 20-2 and 20-3. Each additional display surface 20-2 and 20-3 thus has a display screen implemented according to the distributed type architecture. The acquisition module 22 of the display system 10 is associated with each display surface 20-1, 20-2 and 20-3, and is able to acquire commands exercised in relation to each of these display surfaces.

In the example shown in FIG. 3, the display system 10 further comprises a display chain 49 comprising a second main display surface 50. This display chain 49 is also connected to the two additional display surfaces 20-2 and 20-3 as shown in FIG. 3.

Like the display chain 48, the display chain 49 is, for example, implemented using an integrated type architecture and comprises a processing module and a graphic generation module similar to those described above. For the sake of simplicity, only the second main display surface 50 is shown in FIG. 3.

Advantageously, one of the display chains 48, 49 can form a “COM” type processing chain and the other a “MON” type processing chain. In other words, display chains 48, 49 are designed to operate in parallel.

In the normal operating mode, the graphic generation module 14 of FIG. 3 is able to transmit a single graphic flow to the main display surface 20-1.

This simple graphic flow includes, for example, the images generated by applications 30-1, 30-2, 30-3 in FIG. 3.

The main display surface 20-1 is thus able to represent this simple graphic flow.

In the normal operating mode, the graphic generation module 14 is also able to generate a composite graphic flow from the images supplied by the application 30-4 hosted on the processing module 12.

This composite graphic flow can only be displayed on the additional display surface 20-2 connected directly to the graphic generation module 14.

In the normal operating mode, the display on the display surfaces 50 and 20-3 is implemented in a similar way by the display chain 49.

The degraded operating mode may occur, for example, when the main display surface 50 is no longer available or the display chain 49 has another type of fault.

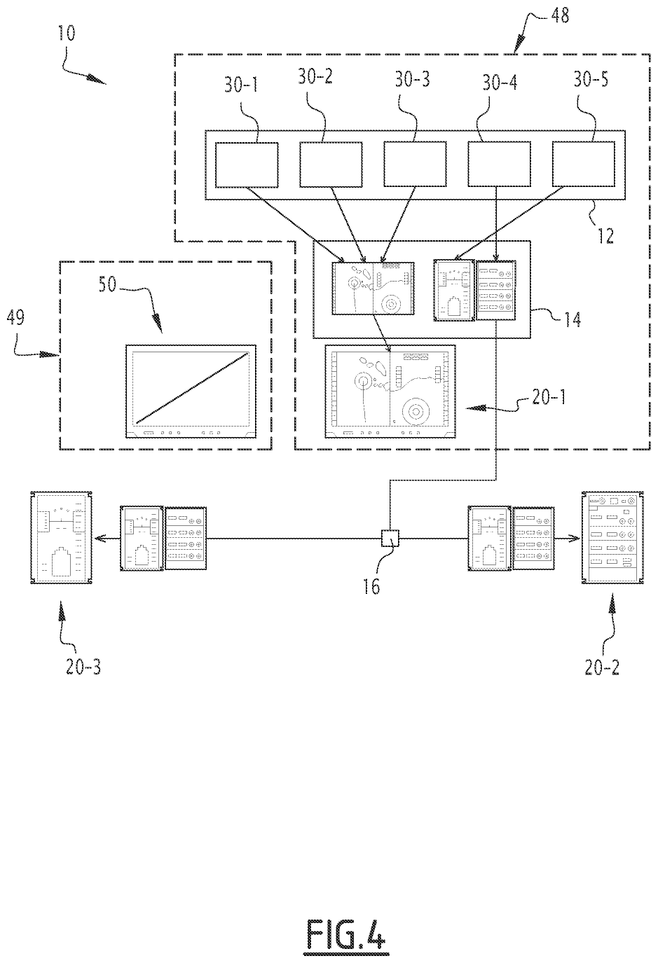

This case is illustrated in greater detail in FIG. 4.

In particular, in such a case, the processing module 12 of the display chain 48 is able to still implement the application 30-5 which corresponds to the capacity lost by the other display chain 49.

In this case, the graphic generation module 14 is able to generate a composite graphic flow from images supplied both by the application 30-4, as was the case in the normal operating mode, and also from the application 30-5.

Also as in the previous case, the graphic generation module 14 is also able to generate a simple graphic flow for the main display surface 20-1. This simple graphic flow remains unchanged from that in normal operating mode.

The composite graphic flow is then duplicated between the additional display surfaces 20-2, 20-3. To do this, the splitter device 16 is arranged between these additional display surfaces 20-2, 20-3 and the main display surface 20-1.

On receiving the composite graphic flow, the additional display surface 20-2 then extracts from it the images generated by the application 30-4, while the additional display surface 20-3 extracts from this composite graphic flow the images generated by the application 30-5.

To do this, the processing module 12 or the graphic generation module 14 may transmit configuration parameters to this additional display surface 20-3, signaling that it should process the composed graphic flow instead of the graphic flow transmitted by the display surface 50.

Of course, other examples of display surface arrangements are also possible.

For example, it is possible to connect the additional display surfaces 20-2, 20-3 indirectly to the graphic generation module 14, for example via the main display surface 20-1. It is also possible to control the operation of the splitter device 16 so that it separates only in the degraded operating mode, for example.

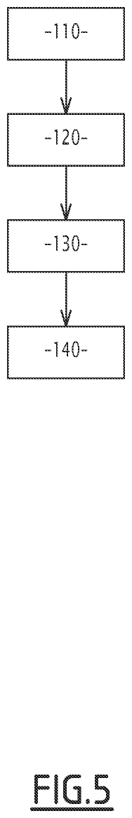

The aircraft cockpit display method implemented by the display system 10 will now be explained with reference to FIG. 5, which illustrates a flowchart of its steps.

In an initial step 110, the applications 30 hosted by the processing module 12 generate images to be displayed on one or more display surfaces 20.

In the next step 120, the graphic generation module 14 generates graphic flows comprising the images from these applications 30.

In particular, the graphic generation module 14 generates a composite graphic flow comprising images from one or more applications 30 that are intended to be displayed on different display surfaces 20.

Advantageously, the graphic generation module 14 also generates a simple graphic flow from the images intended to be displayed on a single display surface 20.

In the next step 130 the display surfaces receive the graphic flows generated by the graphic generation module 14.

In particular, at least two display surfaces receive the same composite graphic flow generated by the graphic generation module 14.

Advantageously, at least one other display surface also receives a simple graphic flow.

In the next step 140, each of the display surfaces 20 that has received the composite graphic flow extracts images corresponding to it from this flow.

For example, when the composite graphic flow comprises images intended to be displayed on two different display surfaces 20, each of these display surfaces 20 extracts the images specific to that display surface 20.

In addition, during this extraction and as mentioned above, each display surface 20 can adapt the images received, for example by scaling or modifying the resolution using techniques known per se.

Display surfaces 20 that have received the single graphic flow can then display it directly.

Also, as mentioned above, at least some display surfaces can simply pass through simple or composite graphic flows without displaying the images contained in these streams.

In addition, images are extracted from the corresponding streams according to configuration parameters transmitted in advance by the processing module 12 or the graphic generation module 14, for example.

When the display system 10 must change its operating mode, for example from normal operating mode to degraded operating mode following, for example, a failure in a display chain, processing module 12 or graphic generation module 14 provides the corresponding display surfaces with new configuration settings to modify the way images are extracted by the corresponding display surfaces.

It is therefore clear that the present invention has a number of advantages.

Firstly, the invention enables a single graphic generation module and a single processing module to be used for a number of display surfaces greater than the number of graphic flows it can normally generate. This means that the computing resources of these modules can be exploited to the full, reducing their number where necessary.

It also reduces the weight, volume, cost and wiring of the display system installation.

The invention remains particularly advantageous when it is necessary to implement several display chains, for example in parallel.

In this case, if one of the display chains fails, the other display chain can take over to prevent the complete loss of display surfaces.

Finally, the display system according to the invention requires very few modifications to the existing display system. In particular, generally speaking, only the addition of a splitter device 16 may be necessary.

However, this addition can be made in a particularly simple way, as the operation itself of such a splitter device is simple given that it has a passive device.

1. A display system in an aircraft cockpit, comprising:
a plurality of display surfaces;
a processing module hosting applications that generate images for display on one or more of said display surfaces; and
a graphic generation module configured to generate a composite graphic flow comprising images from one or more applications for display on different ones of said display surfaces, wherein each display surface receives the composite graphic flow and extracts images for display on that display surface.

2. A display system according to claim 1, further comprising a splitter device receiving the composite graphic flow and dividing it into at least two identical graphic flows to be received by different ones of said display surfaces.

3. A display system according to claim 2, wherein said splitter device comprises a passive device.

4. A display system according to claim 3, wherein said splitter device comprises an optical splitter.

5. A display system according to claim 1, wherein said graphic generation module generates a simple graphic flow comprising images from one or more applications for display on a single display surface.

6. A display system according to claim 1, wherein each display surface adapts, on receipt of the composite graphic flow, the images corresponding to that display surface, using configuration parameters.

7. A display system according to claim 1, further comprising an acquisition module configured to acquire each command exerted in relation to each display surface and to transmit the command to said processing module, wherein said processing module processes each command acquired by said acquisition module, as a function of the display surface that corresponds to the command.

8. A display system according to claim 7, wherein said processing module processes each command acquired by said acquisition module according to a reference frame corresponding to the display surface that corresponds to the command.

9. A display system according to claim 1, further comprising:
a main display surface connected to said graphic generation module; and
at least two additional display surfaces.

10. A display system according to claim 9, wherein at least two additional display surfaces are connected to said graphic generation module.

11. A display system according to claim 9, wherein said processing module is operative to:
in a normal operating mode, generate a composite flow comprising images for display only by one of said additional display surfaces; and
in a degraded operating mode, generate a composite flow comprising images for display on each of said additional display surfaces, wherein each additional display surface receives the composite graphic flow and extracts images for display on that display surface.

12. A method of display in an aircraft cockpit, comprising:
generating images to be displayed on one or more display surfaces by one or more applications;
generating a composite graphic flow comprising images from one or more applications and intended to be displayed on different display surfaces;
receiving the graphic flow composed by each display surface; and
extracting images to be displayed on the corresponding display surface.
